(19) United States
(12) Patent Application Publication
(10) Pub. No.: US 2014/0180753 A1
(43) Pub. Date: Jun. 26, 2014

(54) EVALUATING THE RELIABILITY OF ACTIVITY FORECASTS

(71) Applicant: INTERNATIONAL BUSINESS MACHINES CORPORATION, Armonk, NY (US)

(72) Inventors: Giulia Scerrato, Ferentino (IT); Antonio M. Sgro, Fiumicino (IT)

(73) Assignee: International Business Machines Corporation, Armonk, NY (US)

(21) Appl. No.: 13/724,101

(22) Filed: Dec. 21, 2012

(51) Int. Cl. G06Q 10/06

(52) U.S. Cl. CPC G06Q 10/0633
USPC 705/7.27

(57) ABSTRACT

Embodiments of the present invention disclose a method, computer program product, and system for evaluating the reliability of an activity forecast. A computer identifies forecast information for an activity, where the forecast information can include at least one forecasted time duration to finish the activity, an actual time duration of the activity, a highest forecasted time duration of the activity, and an individual that provided the identified forecast information. The computer utilizes the forecast information to generate a normalized Cartesian plot of the identified forecast information. The computer determines a best-fit line for the normalized Cartesian plot. The computer determines a variance between the best-fit line for the normalized Cartesian plot and the actual time duration of the activity. The computer determines an accuracy rating corresponding to the variance of the forecast information.

### FIELD OF THE INVENTION

The present invention relates generally to the field of project management, and more particularly to evaluating the reliability of forecasts.

### BACKGROUND OF THE INVENTION

Project management is the planning controlling of resources in order to progress a specific task to completion. A project is composed of multiple activities managed in regards to the schedule of the overall project. Forecasting the time duration of a project is an important aspect of project management. Project forecasts often involve data analysis for the performance history for the particular project. The data analysis can be derived from several knowledge areas (i.e. past experiences, training courses, project team member skills, and lessons learned). Forecasting allows project managers to estimate hours to be allotted to activities and resources based on the forecasts by the members of the project team. In many instances, a project may be passed on or stopped if the forecast is deemed to be unfavorable. This indicates that project forecasting is very important to managing projects, and obtaining an accurate forecast for a project is very desirable.

### SUMMARY

Embodiments of the present invention disclose a method, computer program product, and system for evaluating the reliability of an activity forecast. A computer identifies forecast information for an activity, where the forecast information can include at least one forecasted time duration to finish the activity, an actual time duration of the activity, a highest forecasted time duration of the activity, and an individual that provided the identified forecast information. The computer utilizes the forecast information to generate a normalized Cartesian plot of the identified forecast information. The computer determines a best-fit line for the normalized Cartesian plot. The computer determines a variance between the best-fit line for the normalized Cartesian plot and the actual time duration of the activity. The computer determines an accuracy rating corresponding to the variance of the forecast information. In another embodiment, the computer determines a productivity index value for the forecast information and assigns the productivity index value to the individual that provided the forecast information.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is a flowchart depicting operational steps of a program for analyzing forecast information for an activity, in accordance with an embodiment of the present invention.

FIG. 3 is a flowchart depicting operational steps of a program for determining an accuracy rating for a set of forecast information, in accordance with an embodiment of the present invention.

FIG. 4 is a flowchart depicting operational steps of a program for determining a speed rating for a set of forecast information, in accordance with an embodiment of the present invention.

FIG. 5 is a flowchart depicting operational steps of a program for determining a productivity index value for a set of forecast information, in accordance with an embodiment of the present invention.

FIGS. 6 A, B, C are graphical depictions of exemplary forecast information utilized by forecast analysis program 200, in accordance with an embodiment of the present invention.

FIG. 6D is a graphical depiction of exemplary forecast information utilized by accuracy analysis program 300, in accordance with an embodiment of the present invention.

FIG. 6E is a graphical depiction of exemplary forecast information utilized by speed analysis program 400, in accordance with an embodiment of the present invention.

FIG. 7A is a table depicting exemplary accuracy rating values utilized by accuracy analysis program 300, in accordance with an embodiment of the present invention.

FIG. 7B is a table depicting exemplary speed rating values utilized by speed analysis program 400, in accordance with an embodiment of the present invention.

FIG. 8 depicts a block diagram of components of the computing system of FIG. 1 in accordance with an embodiment of the present invention.

### DETAILED DESCRIPTION

Embodiments of the present invention recognize that in many instances allocating activities to project team members can be a complex task. The members of the project team can have a differing understanding and/or experience with the specific technology. The allocation of activities to certain project team members can add risk to the project schedule, as well as the success of the project. When a project is forecasted, the forecast can be impacted by incomplete information, or certain behaviors (i.e. advising more/less time that is required). These factors can cause the forecast for one project to be different when done by different members of the team. Embodiments of the present invention can determine a grade of reliability responsive to a project team member's ability to forecast activities.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

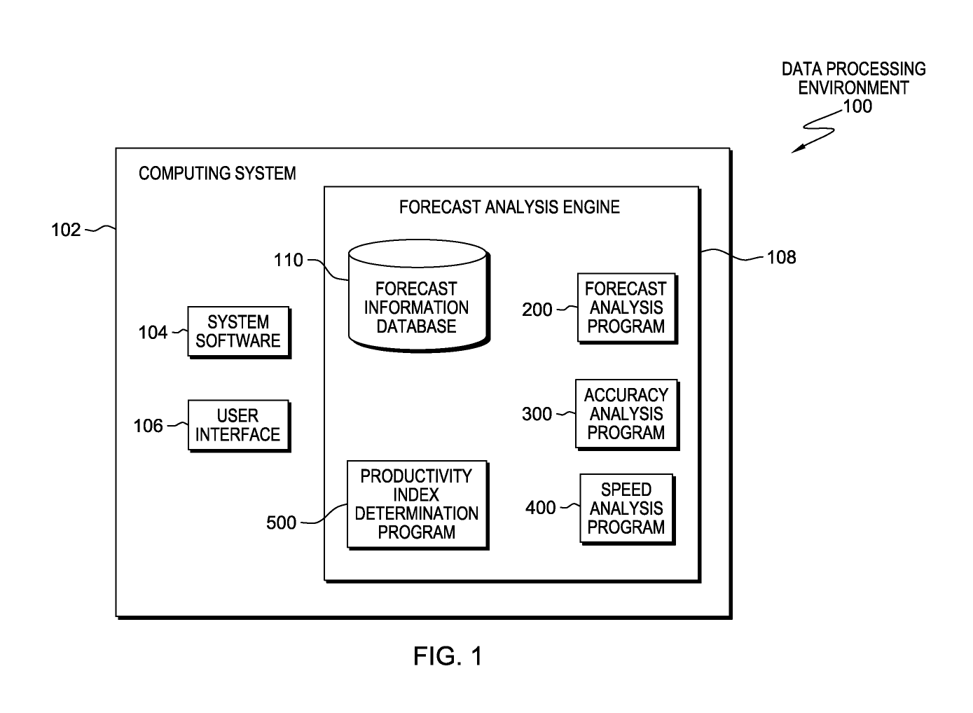

The present invention will now be described in detail with reference to the Figures. FIG. 1 is a functional block diagram illustrating a data processing environment 100, in accordance with one embodiment of the present invention.

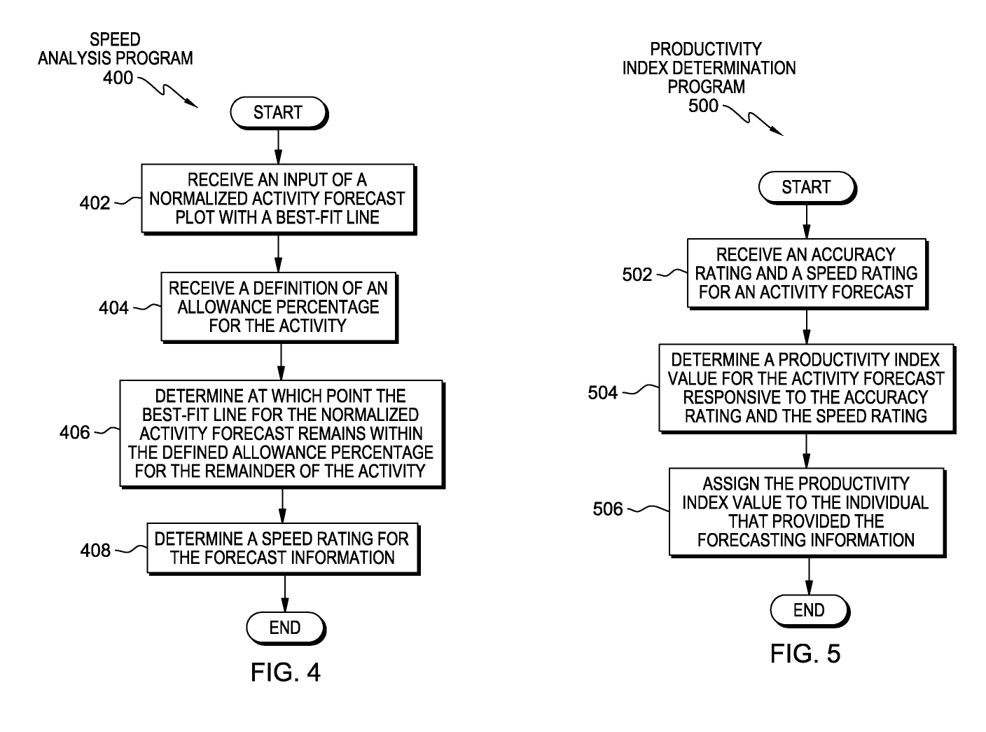

Data processing environment 100 includes computing system 102. In various embodiments of the present invention, computing system 102 may be a workstation, personal computer, personal digital assistant, mobile phone, or any other device capable of executing program instructions. In general, computing system 102 is representative of any electronic device or combination of electronic devices capable of executing machine-readable program instructions, as described in greater detail with regard to FIG. 4. In another embodiment, computing system 102 can be a desktop computer, specialized computer server, or any other computer system known in the art. System software 104 is located on computing system 102 and may exist in the form of operating system software, which may be Windows®, LINUX®, and other application software such as internet applications and web browsers. Computing system 102 includes a user interface 106 to allow a user of computing system to input information into a forecast analysis engine 108.

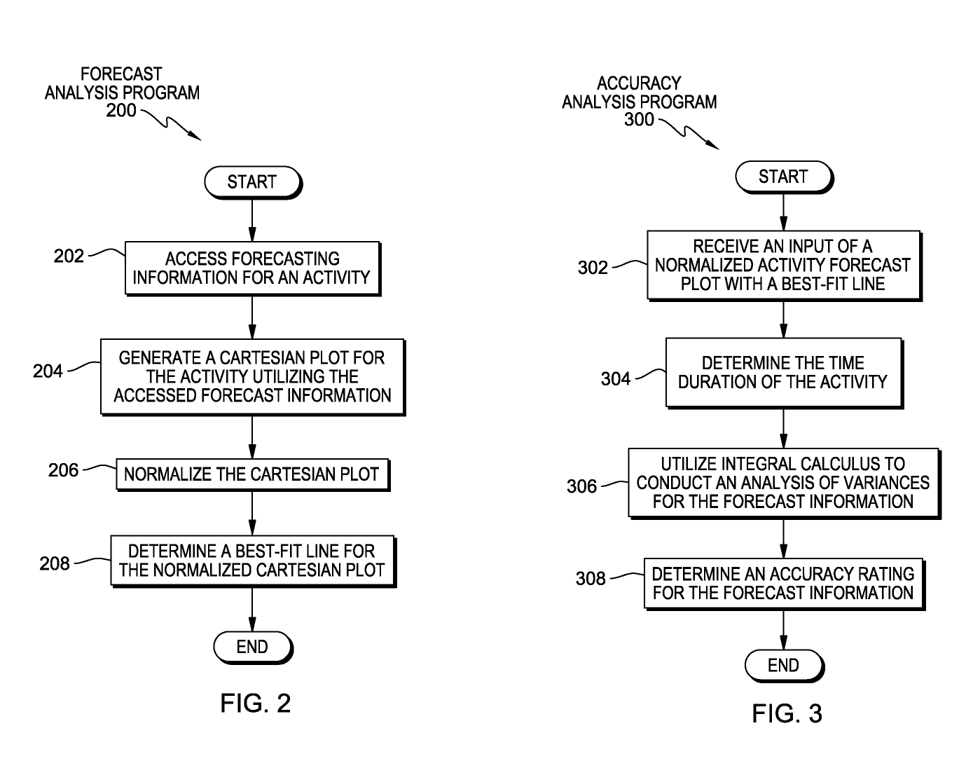

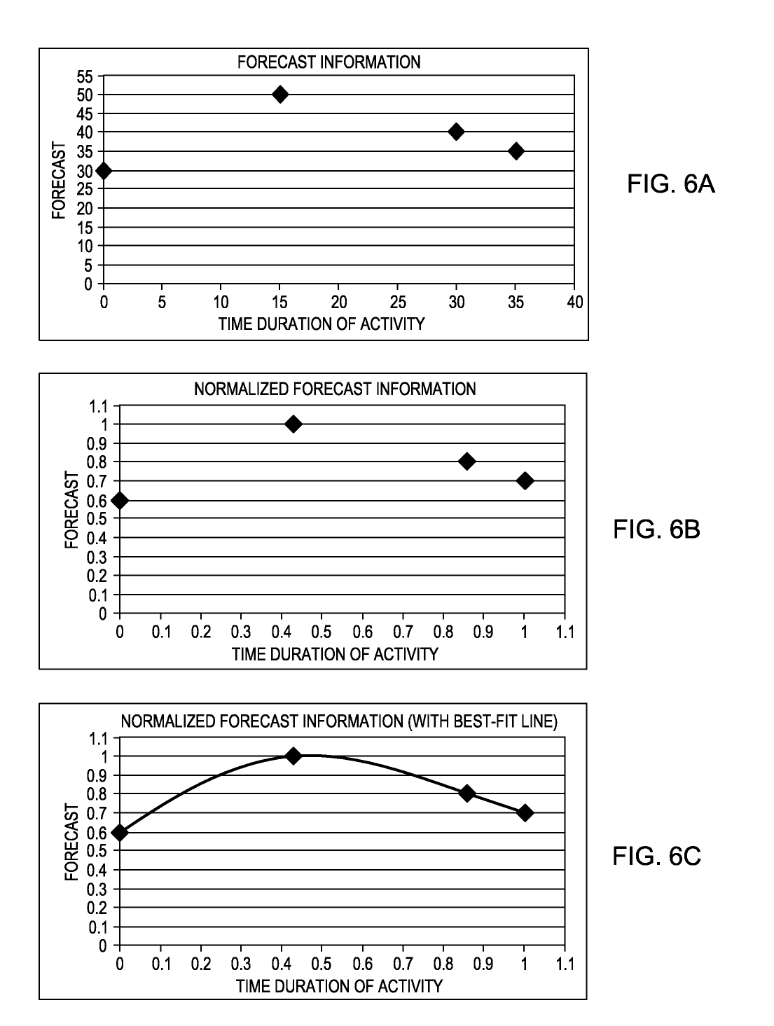

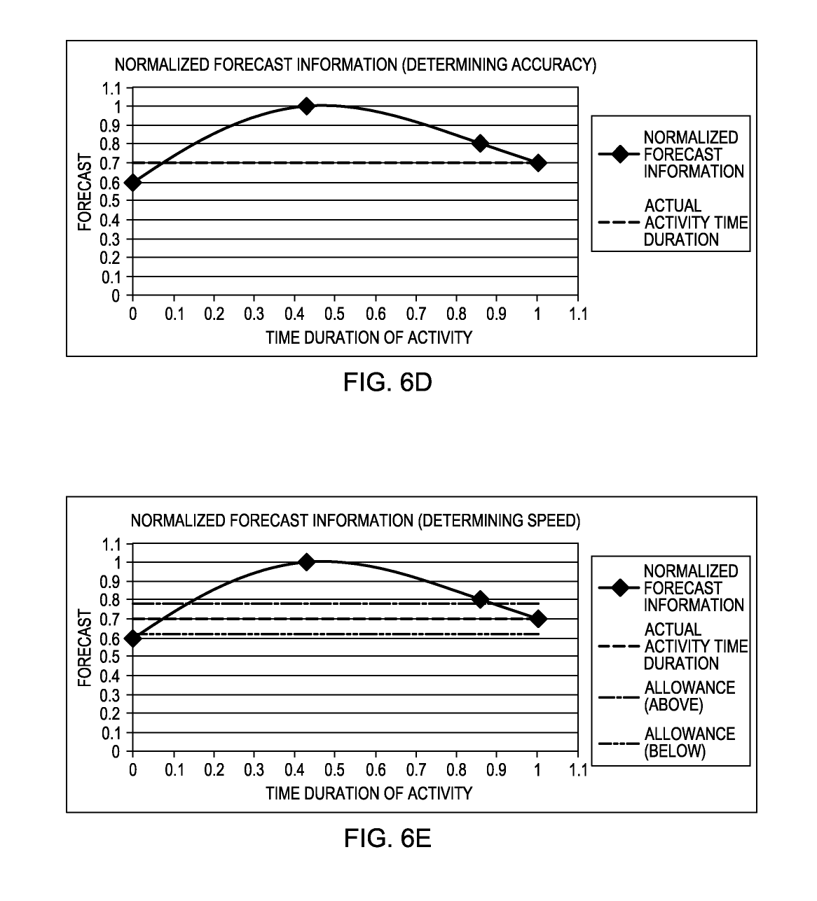

Forecast analysis engine 108 includes a forecast information database 110. In one exemplary embodiment, forecast analysis program 200, accuracy analysis program 300, speed analysis program 400, and productivity index determination program 500 exist in the form of programs located on forecast analysis engine 108. Forecast analysis engine 108 can be a collection of programs and information that can analyze forecast information, as will be discussed in further detail with regard to FIGS. 2 through 5. In another embodiment, forecast analysis engine 108 may be a server computer located on computing system 102, or a remote server computer in data processing environment 100 that can communicate with computing system. In general, forecast analysis engine 108 is representative of any electronic device or combination of electronic devices capable of executing machine-readable program instructions, as described in greater detail with regard to FIG. 4. Forecast information database 110 can be implemented with any type of storage device capable of storing data which may be accessed and utilized by computing system 102 and other elements of forecast analysis engine 108, such as a database server, a hard disk drive, or flash memory. In one embodiment, forecast information database 110 includes forecast information for activities and individuals that provided the activity forecasts. Forecast information may include, at least in part, the projected end date of an activity throughout the life of the activity, and the individual responsible for forecasting the activity. In one embodiment, the projected end date of the activity throughout the life of the activity is at least one forecasted time duration to finish the activity corresponding to a number of days that have elapsed since the activity began (i.e. in FIG. 6A, on day 15, the activity was forecasted to have a time duration of 50 days). In one example, an activity may have an update of the projected end date every week, and that information would be included in forecast information for that activity. Forecast information can be input into forecast information database 110 through user interface 106 on computing system 102. In another embodiment, forecast information database 110 includes grading information and penalty information. Grading information can provide a measure of reliability of a forecast when the forecast is analyzed. Penalty information can provide a manner for penalizing forecasting errors depending on when errors occur within the life of the activity.

In one embodiment, forecast analysis program 200, accuracy analysis program 300, speed analysis program 400, and productivity index determination program 500 work in conjunction with forecast analysis engine 108 to determine a productivity index value for a set of forecast information.

FIG. 2 is a flowchart depicting operational steps of forecast analysis program 200 in accordance with an exemplary embodiment of the present invention. In exemplary embodiments, forecast analysis program 200 normalizes a plot of forecast information to determine a best-fit line equation for the plot of forecast information.

In step 202, forecast analysis program 200 accesses forecast information for an activity. In one embodiment, forecast analysis program 200 accesses and identifies forecast information stored in forecast information database 110. Exemplary embodiments of forecast information include the individual that provided the forecast information, projected end dates for the activity throughout the life of the activity, an actual time duration of the activity, and a highest forecasted time duration of the activity. An exemplary set of forecast information can include a forecasted time duration to finish the activity corresponding to a number of days that have elapsed since the activity began.

In step 204, forecast analysis program 200 generates a Cartesian plot for the activity utilizing the accessed forecast information. In one embodiment, the x-axis of the plot depicts actual days from the beginning to the end of the activity, and the y-axis depicts the number of days forecasted for the activity. The data points in the plot correspond to forecast projections (for the total time duration of the activity), and the corresponding day that the forecast was made (the y-axis and x-axis values respectively). Forecasts can be subject to alteration throughout the life of the activity. In an exemplary embodiment, forecast information for an activity includes multiple forecasts made on different days of the activity life cycle. In one embodiment, the final data point in the Cartesian plot is the actual end date for the activity (this would not be a forecasted date, instead reflecting that the activity had completed on a certain date). FIG. 6A depicts an exemplary Cartesian plot for a set of forecast information. In the example depicted in FIG. 6A, an activity has been forecasted at the beginning of the activity, as well as days 15, 30, and the activity finishes on day 35. In this example, data points at days 0, 15, 30 and 35 correspond to forecasts of 30, 50, 40, and 35 days respectively. The final data point at day 35 indicates the end day of the activity.

In step 206, forecast analysis program 200 normalizes the Cartesian plot. In one embodiment, forecast analysis program 200 normalizes forecast information in the Cartesian plot dividing (for each data point in the Cartesian plot) the x-axis value (day which a forecast was made) by the effective duration of the activity, and dividing the y-axis (forecast) by the highest forecast value. The normalization process allows for a comparison of forecast information for activities of different time durations, and therefore allows individuals across different activities to be able to compare forecasting reliability. FIG. 6B depicts a normalized forecast information plot corresponding to forecast information plot depicted in FIG. 6A.

In step 208, forecast analysis program 200 determines a best-fit line for the normalized Cartesian plot. In one embodiment, linear interpolation can be used to determine the best-fit line for the normalized forecast information. In another embodiment, step 208 can include methods to penalize errors that occur at different points in the activity (i.e. add a more severe penalty for an error that is made at the beginning of the activity or equally penalize errors throughout the duration of an activity). Implementation of the penalty can occur through including a probability distribution (i.e. an inverse Gaussian distribution) in the best-fit line determination for the normalized Cartesian plot. In one embodiment, the penalization of errors modifies the best-fit line, which in turn impacts the accuracy and speed ratings (discussed with regard to FIG. 3 and FIG. 4) for the forecast information. In exemplary embodiments, accuracy analysis program 300 stores the normalized Cartesian plot along with the best-fit line in forecast information database 110. FIG. 6C depicts the plot of normalized forecast information (from FIG. 6B) with the appropriate best-fit line (determined through linear interpolation without using a penalization equation).

FIG. 3 is a flowchart depicting operational steps of accuracy analysis program 300 in accordance with an embodiment of the present invention. In one embodiment, accuracy analysis program 300 initiates after forecast analysis program 200 and determines how accurate forecasts for an activity are in comparison to the actual end time for the activity.

In step 302, accuracy analysis program 300 receives an input of a normalized activity forecast plot with a best-fit line. In one embodiment, forecast analysis program 200 determines the normalized activity forecast plot with a best-fit line, which is stored in forecast information database 110.

In step 304, accuracy analysis program 300 determines the actual time duration of the activity. In one embodiment, the final forecast of the activity, which is depicted as the final data point in FIG. 6A (and also FIGS. 6B, and 6C), indicates the actual time duration of the activity.

In step 306, accuracy analysis program 300 utilizes integral calculus to conduct an analysis of variances for the forecast information. In one embodiment, the analysis of variances calculates the area between a normalized forecast information function and a line indicating actual duration of the activity. The following exemplary integral can be used to complete the analysis of variances:

$${\int }_{0}^{{x}_{0}} \vert f ( x ) - {y}_{0} \vert d x$$

where f(x) is a normalized forecast information function, x₀ is an actual time duration of the activity, and y₀ is a line indicating actual duration of the activity.

In one embodiment of the analysis of variances (as depicted in the exemplary integral), the absolute value of the area between the normalized forecast information function and the line indicating the actual duration of the activity is used in order to avoid a counter balance between overestimating and underestimating. FIG. 6D depicts a plot that includes a normalized forecast information function and a line indicating actual duration of the activity. The exemplary integral can be applied to FIG. 6D in order to conduct the analysis of variances.

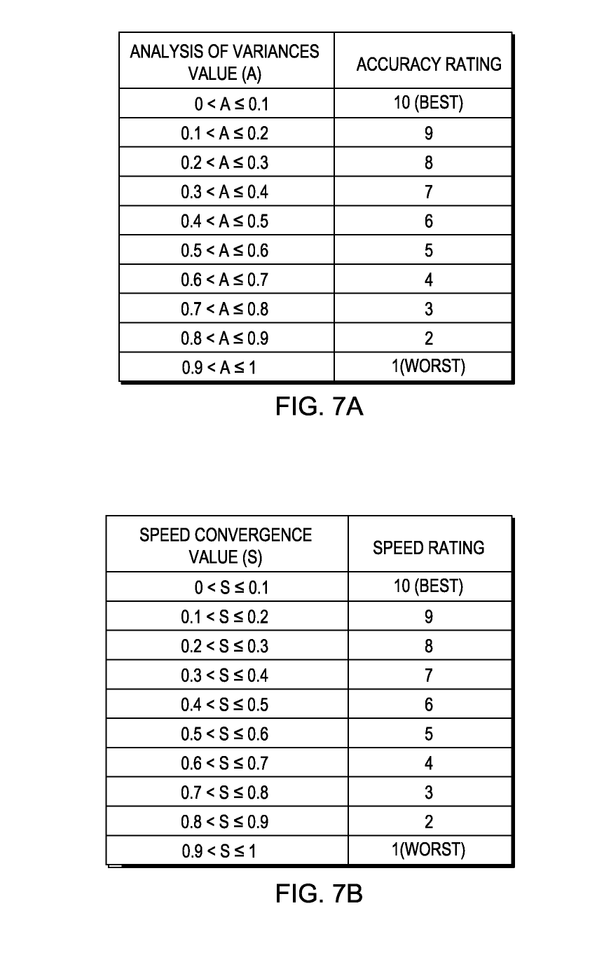

In step 308, accuracy analysis program 300 determines an accuracy rating for the forecast information. In one embodiment, accuracy analysis program 300 determines accuracy through assignment of a numerical rating value that corresponds to the result of the analysis of variances conducted in step 306. Since the analysis of variances is conducted on the normalized forecast information function, the result is a number between zero and one (and can include zero or one). FIG. 7A depicts an exemplary table for assigning accuracy ratings to values from the analysis of variances. In an example, if the analysis of variances determines a value of 0.07, accuracy analysis program 300 assigns an accuracy rating of 10 to the forecast information. The accuracy score indicates how much the forecast information deviates from the actual time duration of the activity.

FIG. 4 is a flowchart depicting operational steps of speed analysis program 400 in accordance with an exemplary embodiment of the preset invention. In one embodiment, speed analysis program 400 initiates after forecast analysis program 200 and determines the amount of time that it takes for forecast information to converge within a defined allowance of the actual time duration of the activity.

In step 402, speed analysis program 400 receives an input of a normalized activity forecast plot with a best-fit line. In one embodiment, the normalized activity forecast plot with a best-fit line was determined in forecast analysis program 200, and is received from forecast information database 110.

In step 404, speed analysis program 400 receives a definition of an allowance percentage for the activity. In one embodiment, the project manager for an activity can assign the allowance percentage for the activity at the manager's discretion. FIG. 6E depicts a plot of normalized forecast information for an activity with the allowance percentage depicted as dotted lines above and below the actual activity time duration.

In step 406, speed analysis program 400 determines at which point the best-fit line for the normalized activity forecast remains within the defined allowance percentage for the remainder for the activity. In one embodiment, speed analysis program 400 utilizes a plot of normalized forecast information with a line indicating the actual duration of the activity (an example depiction in FIG. 6D), and adds the allowance percentage to the plot corresponding to the actual activity time duration (an example depiction in FIG. 6E). In the example of FIG. 6E, the two dotted lines (at forecast values of 0.77 and 0.63) indicate an allowance value of 10%. At an approximate (normalized) activity time duration of 0.91, the (normalized) forecast information comes within the allowance and remains within the allowance for the remainder of the activity; therefore speed analysis program 400 determines a value of 0.91. In another embodiment, speed analysis program 400 only determines the point which the forecast information comes within the allowance and remains within the allowance for the remainder of the activity.

In step 408, speed analysis program 400 determines a speed rating for the forecast information. In one embodiment, speed analysis program 400 determines the speed rating through assigning a numerical rating value that corresponds to the value determined in step 406. Since the value is determines on the normalized forecast information function, the result is a number between zero and one (and can include zero or one). FIG. 7B depicts an exemplary table for assigning speed rating to speed values. In an example, speed analysis program 400 determines a speed value of 0.91, which assigns a speed score of 1 to the forecast information. The speed score indicates the amount of time that it takes for forecast information to converge within the defined allowance percentage.

FIG. 5 depicts a flowchart depicting operational steps of productivity index determination program 500 in accordance with an exemplary embodiment of the present invention. In one embodiment, productivity index determination program 500 initiates after accuracy analysis program 300 and speed analysis program 400 terminate, and determines a productivity index value for the individual that provided the forecast information.

In step 502, productivity index determination program 500 receives an accuracy rating and a speed rating for an activity forecast. In one embodiment, productivity index determination program 500 receives the accuracy rating from accuracy analysis program 300, and the speed rating from speed analysis program 400.

In step 504, productivity index determination program 500 determines a productivity index value for the activity forecast responsive to the accuracy rating and the speed rating inputs. In one embodiment, productivity index determination program 500 creates the productivity index value as a set of the accuracy rating and the speed rating. In an example where the accuracy rating is 10, and the speed rating is 1, the productivity index value is (10,1). In another example, productivity index determination program 500 can create the productivity index value as a sum, product or average of the accuracy rating and the speed rating.

In step 506, productivity index determination program 500 assigns the productivity index value to the individual that provided the forecast information. Forecast information database 110 specifies the individual that provided the forecast information for the activity. In one embodiment, productivity index determination program 500 assigns the productivity index value by adding the productivity index value to the forecast information corresponding to the activity in forecast information database 110.

FIGS. 6 A, B, C, D, and E are graphical depictions of forecast information in accordance with various embodiments of the present invention as described herein above.

FIG. 7A depicts a table for assigning an accuracy rating to a set of forecast information, and FIG. 7B depicts a table for assigning a speed rating to a set of forecast information in accordance with embodiments of the present invention.

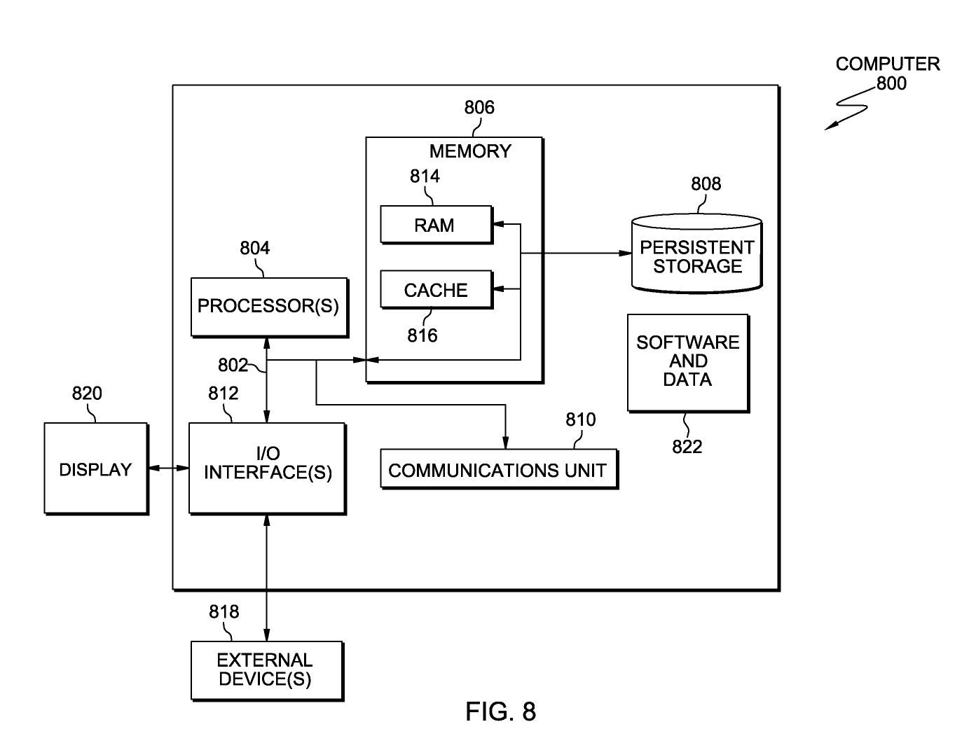

FIG. 8 depicts a block diagram of components computer 800, representative of computing system 102 and forecast information database 110, in accordance with an illustrative embodiment of the present invention. It should be appreciated that FIG. 8 provides only an illustration of one implementation and does not imply any limitations with regard to the environments in which different embodiments may be implemented. Many modifications to the depicted environment may be made.

Computer 800 includes communications fabric 802, which provides communications between computer processor(s) 804, memory 806, persistent storage 808, communications unit 810, and input/output (I/O) interface(s) 812. Communications fabric 802 can be implemented with any architecture designed for passing data and/or control information between processors (such as microprocessors, communications and network processors, etc.), system memory, peripheral devices, and any other hardware components within a system. For example, communications fabric 802 can be implemented with one or more buses.

Memory 806 and persistent storage 808 are computer-readable storage media. In this embodiment, memory 806 includes random access memory (RAM) 814 and cache memory 816. In general, memory 806 can include any suitable volatile or non-volatile computer-readable storage media. Software and data 822 can be stored in persistent storage 808 for access and/or execution by processor(s) 804 via one or more memories of memory 806. With respect to forecast analysis engine 108, software and data 822 can include forecast analysis program 200, accuracy analysis program 300, speed analysis program 400, and productivity index determination program 500.

In this embodiment, persistent storage 808 includes a magnetic hard disk drive. Alternatively, or in addition to a magnetic hard disk drive, persistent storage 808 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 808 may also be removable. For example, a removable hard drive may be used for persistent storage 808. Other examples include optical and magnetic disks, thumb drives, and smart cards that are inserted into a drive for transfer onto another computer-readable storage medium that is also part of persistent storage 808.

Communications unit 810, in these examples, provides for communications with other data processing systems or devices. In these examples, communications unit 810 includes one or more network interface cards. Communications unit 810 may provide communications through the use of either or both physical and wireless communications links. Software and data 822 may be downloaded to persistent storage 808 through communications unit 810.

I/O interface(s) 812 allows for input and output of data with other devices that may be connected to computer 800. For example, I/O interface 812 may provide a connection to external devices 818 such as a keyboard, keypad, a touch screen, and/or some other suitable input device. External devices 818 can also include portable computer-readable storage media such as, for example, thumb drives, portable optical or magnetic disks, and memory cards. Software and data 822 can be stored on such portable computer-readable storage media and can be loaded onto persistent storage 808 via I/O interface(s) 812. I/O interface(s) 812 also connect to a display 820.

Display 820 provides a mechanism to display data to a user and may be, for example, a computer monitor. Display 820 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for evaluating the reliability of an activity forecast, the method comprising the steps of:
a computer identifying forecast information for an activity, the identified forecast information comprising, at least one forecasted time duration to finish the activity, an actual time duration of the activity, a highest forecasted time duration of the activity and an individual that provided the identified forecast information;
the computer generating a normalized Cartesian plot utilizing the identified forecast information;
the computer determining a best-fit line for the normalized Cartesian plot;
the computer identifying an allowance percentage for the forecast information, wherein the allowance percentage is assigned to the activity, and defines a value above and below the actual time duration of the activity;
the computer determining a point at which the best-fit line for the normalized Cartesian plot remains within the identified allowance percentage from the determined point through the remaining time duration of the activity; and
the computer determining a speed rating corresponding to the identified forecast information, wherein the speed rating is based on the determined point at which the best-fit line for the normalized Cartesian plot remains within the identified allowance percentage from the determined point through the remaining time duration of the activity.

2. The method of claim 1, wherein said at least one forecasted time duration to finish the activity corresponds to a number of days that have elapsed since the activity began.

3. The method of claim 1, wherein said generating a normalized Cartesian plot utilizing the identified forecast information includes the steps of:
the computer generating normalized forecast information for the activity forecast, wherein a point that corresponds to the activity forecast is determined by dividing a number of days that have elapsed since the activity began by the actual time duration of the activity, and dividing a forecasted time duration to finish the activity corresponding to the number of days elapsed since the activity began by the highest forecasted time duration of the activity; and
the computer generating the normalized Cartesian plot by utilizing the normalized forecast information, wherein x-axis values of the generated normalized Cartesian plot corresponding to a number of days that have elapsed since the activity began divided by the actual time duration of the activity, and y-axis values of the generated normalized Cartesian plot corresponding to the forecasted time duration to finish the activity corresponding to the number of days that have elapsed since the activity began divided by the highest forecasted time duration of the activity.

4. The method of claim 1, wherein said determining a best-fit line for the normalized Cartesian plot comprises the steps of:
the computer identifying an error penalization method for the identified forecast information; and
the computer utilizing the identified error penalization method and determining a best-fit line for the normalized Cartesian plot using linear interpolation.

5. (canceled)

6. The method of claim 1, further comprising the steps of:
the computer determining a variance between the best-fit line of the Cartesian plot of the identified forecast information and the actual time duration of the activity; and
the computer determining an accuracy rating corresponding to the variance of the identified forecast information, wherein the accuracy rating is based on the determined variance between the best-fit line of the Cartesian plot of the identified forecast information and the actual time duration of the activity.

7. The method of claim 6, further comprising the steps of:
the computer determining a productivity index value for the identified forecast information, the productivity index value comprising, a set including the accuracy rating and the speed rating; and
the computer assigning the productivity index value to the individual that provided the identified forecast information.

8. A computer program product for evaluating the reliability of an activity forecast, the computer program product comprising:
one or more computer-readable storage devices and program instructions stored on the one or more computer-readable storage devices, the program instructions comprising:
program instructions to identify forecast information for an activity, the identified forecast information comprising, at least one forecasted time duration to finish the activity, an actual time duration of the activity, a highest forecasted time duration of the activity and an individual that provided the identified forecast information;
program instructions to generate a normalized Cartesian plot utilizing the identified forecast information;
program instructions to determine a best-fit line for the normalized Cartesian plot;
program instructions to identify an allowance percentage for the forecast information, wherein the allowance percentage is assigned to the activity, and defines a value above and below the actual time duration of the activity;
program instructions to determine a point at which the best-fit line for the normalized Cartesian plot remains within the identified allowance percentage from the determined point through the remaining time duration of the activity; and
program instructions to determine a speed rating corresponding to the identified forecast information, wherein the speed rating is based on the determined point at which the best-fit line for the normalized Cartesian plot remains within the identified allowance percentage from the determined point through the remaining time duration of the activity.

9. The computer program product of claim 8, wherein said at least one forecasted time duration to finish the activity corresponds to a number of days that have elapsed since the activity began.

10. The computer program product of claim 8, wherein the program instructions to generate a normalized Cartesian plot utilizing the identified forecast information, comprise program instructions to:
generate normalized forecast information for the activity forecast, wherein a point that corresponds to the activity forecast is determined by dividing a number of days that have elapsed since the activity began by the actual time duration of the activity, and dividing a forecasted time duration to finish the activity corresponding to the number of days elapsed since the activity began by the highest forecasted time duration of the activity; and
generate the normalized Cartesian plot by utilizing the normalized forecast information, wherein x-axis values of the generated normalized Cartesian plot corresponding to a number of days that have elapsed since the activity began divided by the actual time duration of the activity, and y-axis values of the generated normalized Cartesian plot corresponding to the forecasted time duration to finish the activity corresponding to the number of days that have elapsed since the activity began divided by the highest forecasted time duration of the activity.

11. The computer program product of claim 8, wherein the program instructions to determine a best-fit line for the normalized Cartesian plot, comprise program instructions to:
identify an error penalization method for the identified forecast information; and
utilize the identified error penalization method and determine a best-fit line for the normalized Cartesian plot using linear interpolation.

12. (canceled)

13. The computer program product of claim 8, further comprising program instructions to:
determine a variance between the best-fit line of the Cartesian plot of the identified forecast information and the actual time duration of the activity; and
determine an accuracy rating corresponding to the variance of the identified forecast information, wherein the accuracy rating is based on the determined variance between the best-fit line of the Cartesian plot of the identified forecast information and the actual time duration of the activity.

14. The computer program product of claim 13, further comprising program instructions to:
determine a productivity index value for the identified forecast information, the productivity index value comprising, a set including the accuracy rating and the speed rating; and
assign the productivity index value to the individual that provided the identified forecast information.

15. A computer system for evaluating the reliability of an activity forecast, the computer system comprising:
one or more computer processors;
one or more computer-readable storage media;
program instructions stored on the one or more computer-readable storage media for execution by at least one of the one or more processors, the program instructions comprising:
program instructions to identify forecast information for an activity, the identified forecast information comprising, at least one forecasted time duration to finish the activity, an actual time duration of the activity, a highest forecasted time duration of the activity and an individual that provided the identified forecast information;
program instructions to generate a normalized Cartesian plot utilizing the identified forecast information;
program instructions to determine a best-fit line for the normalized Cartesian plot;
program instructions to identify an allowance percentage for the forecast information, wherein the allowance percentage is to the activity, and defines a value above and below the actual time duration of the activity;
program instructions to determine a point at which the best-fit line for the normalized Cartesian plot remains within the identified allowance percentage from the determined point through the remaining time duration of the activity; and
program instructions to determine a speed rating corresponding to the identified forecast information, wherein the speed rating is based on the determined point at which the best-fit line for the normalized Cartesian plot remains within the identified allowance percentage from the determined point through the remaining time duration of the activity.

16. The computer system of claim 15, wherein said at least one forecasted time duration to finish the activity corresponds to a number of days that have elapsed since the activity began.

17. The computer system of claim 15, wherein the program instructions to generate a normalized Cartesian plot utilizing the identified forecast information, comprise program instructions to:
generate normalized forecast information for the activity forecast, wherein a point that corresponds to the activity forecast is determined by dividing a number of days that have elapsed since the activity began by the actual time duration of the activity, and dividing a forecasted time duration to finish the activity corresponding to the number of days elapsed since the activity began by the highest forecasted time duration of the activity; and
generate the normalized Cartesian plot by utilizing the normalized forecast information, wherein x-axis values of the generated normalized Cartesian plot corresponding to a number of days that have elapsed since the activity began divided by the actual time duration of the activity, and y-axis values of the generated normalized Cartesian plot corresponding to the forecasted time duration to finish the activity corresponding to the number of days that have elapsed since the activity began divided by the highest forecasted time duration of the activity.

18. The computer system of claim 15, wherein the program instructions to determine a best-fit line for the normalized Cartesian plot, comprise program instructions to:
identify an error penalization method for the identified forecast information; and
utilize the identified error penalization method and determine a best-fit line for the normalized Cartesian plot using linear interpolation.

19. (canceled)

20. The computer system of claim 15, further comprising program instructions to:
determine a variance between the best-fit line of the Cartesian plot of the identified forecast information and the actual time duration of the activity; and
determine an accuracy rating corresponding to the variance of the identified forecast information, wherein the accuracy rating is based on the determined variance between the best-fit line of the Cartesian plot of the identified forecast information and the actual time duration of the activity.

21. The computer system of claim 20, further comprising program instructions to:
determine a productivity index value for the identified forecast information, the productivity index value comprising, a set including the accuracy rating and the speed rating; and
assign the productivity index value to the individual that provided the identified forecast information.

22. The method of claim 6, wherein said determining a variance between the best-fit line of the Cartesian plot of the identified forecast information and the actual time duration of the activity comprises the step of:
the computer utilizing integral calculus to determine the area between the best-fit line for the normalized Cartesian plot of the identified forecast information and a line indicating the actual time duration of the activity.

23. The computer program product of claim 13, wherein the program instructions to a variance between the best-fit line of the Cartesian plot of the identified forecast information and the actual time duration of the activity, comprise program instructions to:
utilize integral calculus to determine the area between the best-fit line for the normalized Cartesian plot of the identified forecast information and a line indicating the actual time duration of the activity.

24. The computer system of claim 20, wherein the program instructions to determine a variance between the best-fit line of the Cartesian plot of the identified forecast information and the actual time duration of the activity, comprise program instructions to:
utilize integral calculus to determine the area between the best-fit line for the normalized Cartesian plot of the identified forecast information and a line indicating the actual time duration of the activity.
